(19) United States
(12) Patent Application Publication
(10) Pub. No.: US 2003/0105871 A1
(43) Pub. Date: Jun. 5, 2003

(54) Method and system for modifying lock properties in a distributed environment

(75) Inventor: Jonathan S. Goldick, San Francisco, CA (US)

Correspondence Address: Timothy B. Scull, Merchant & Gould P.C., P.O. Box 2903, Minneapolis, MN, 55402-0903, US

(73) Assignee: Microsoft Corporation,

(21) Appl. No.: 09/992,525

(22) Filed: Nov. 13, 2001

(51) Int. Cl. G06F 15/173; G06F 15/16

(52) U.S. Cl. 709/229; 709/225

(57) ABSTRACT

A method and system that maintains lock properties for a resource or object in a distributed environment. The lock properties provide other client computer systems limited availability to the locked resource. The method and system providing for the modification of a lock object associated with the resource in a distributed environment. Modification allows for the change in lock type, lock scope, lock ownership and/or resource association.

### TECHNICAL FIELD

This invention relates generally to distributed computing environments and particularly to availability management of resources in a distributed environment. More particularly, the present invention relates to methods of “locking” distributed environment resources to prevent inappropriate access to such resources. More particularly still, the present invention relates to server-side management of locks within the WebDAV protocol.

### BACKGROUND OF THE INVENTION

Distributed computer environments, such as computer networks, provide significant advantages to multiple computer clients or users. In particular, distributed environments allow multiple clients to actually share many different computer resources including both hardware and software resources. Sharing software-related resources provides many known benefits, such as the fact that only one such resource needs to be created, updated and maintained.

The Internet is one particular example of a distributed environment that provides access to a considerable number of software resources, which are available to practically any client computer system having Internet capabilities. One portion of the Internet is known as the World Wide Web which is a generally a system of Internet servers that house software related resources that are formatted in a particular manner, such as with HTML (HyperText Markup Language). The protocol for accessing these particular resources is known as the HyperText Transfer Protocol or HTTP. It should be noted however that not all Internet servers are part of the World Wide Web.

With recent advances, clients may effectively author resources on a server system from client systems over distributed networks, including the Internet. For instance, the WebDAV protocol or standard, which stands for the World Wide Web Distributed Authoring and Versioning standard, referred to herein as simply “DAV,” provides a set of headers and methods which extend HTTP to provide capabilities for managing properties, namespace and other items from a client system in order to allow client computer systems to access server-side resources for the purpose of editing those resources. Proposed Standard RFC 2518, which is a document written by the IETF and approved by the IESG, published February 1999, describes DAV in more detail.

As part of the DAV standard, server computer systems provide various services in managing the various access requests made by clients. One particular service relates to controlling when a resource is available for use by a client. That is, DAV provides methods that allow a client to lock a resource when using that resource so that subsequent users may not access that resource during that time. This locking scheme helps prevent the “lost update” problem associated with two or more users modifying a resource simultaneously such that editions are inadvertently lost.

Although the locks are helpful in preventing the lost update problem, the present locking system implemented in DAV is unsatisfactory with respect to the management of these locks. For instance, a DAV lock that is owned by one process cannot be transferred to another process. This problem is somewhat unique to the DAV protocol, in that multiple processes may need access to a particular resource at various times. In other, non-DAV systems, the resource is open, and thus various processes may access the open resource. In those environments, a single processing system is used to enforce control over which resource may access the open resource and at which time. In DAV however, the resources are not open in the same manner and, moreover, there is not just one processing system that may control the resource or the processes that access the resource.

Consequently, controlling the use of resources is typically achieved through the use of locks. These locks however, cannot be transferred from one process to another. Therefore a second process must wait for the resource to be free and, instead of merely getting the lock on the resource, the second process must request a new lock before accessing the resource. This method is unsatisfactory because one user may desire to perform various operations on a resource using different processes. The user must however, give up control over the resource in between the different operations. Indeed in doing so, the user may not complete the series of operations that was intended since an intermediate operation may obtain control and interfere with the operations.

Similarly, the existing DAV protocol does not provide a method by which an existing lock may be modified to change other properties besides ownership, such as lock scope or type. In essence, in order to make changes to lock properties, the owner must give up the existing lock, and then request a new lock. Unfortunately however, existing lock owners are not guaranteed that the resource will be available, i.e., not locked by another user, prior to being allocated the new, modified version of the lock. Therefore, users typically request locks having a more restrictive type, scope, etc. to ensure that the resource is adequately locked for the duration of use by that user.

It is with respect to these and other considerations that the present invention has been made.

### SUMMARY OF THE INVENTION

The present invention solves these problems by providing a system and method of modifying the properties of a lock to effectively transfer ownership of the lock and or change other properties such as lock scope, lock type, or the actual resources that are locked. The method and system of the present invention relates to an update method in DAV that provides owners the ability to modify lock properties without releasing the lock. Modification allows for the change in lock type, lock scope, lock ownership and/or resource association.

In accordance with certain aspects, the present invention relates to a method of locking a resource wherein the method comprises the acts of receiving a request to modify the lock, wherein the request originates from a requesting client computer system and analyzing the request to determine whether the request is made by the lock owner. If the request is made by the lock owner, the method modifies at least one property associated with the lock. Additionally, the method may further determine whether the resource is locked by another client computer system that may conflict with the requested modification and if the resource is locked by a conflicting lock, denying the received request. In various embodiments, the received request relates to modifying the lock type, lock scope, lock ownership and/or lock association.

The invention may be implemented as a computer process, a computing system or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

A more complete appreciation of the present invention and its improvements can be obtained by reference to the accompanying drawings, which are briefly summarized below, to the following detail description of presently preferred embodiments of the invention, and to the appended claims.

### BRIEF DESCRIPTION OF THE DRAWINGS

FIG. 1 is a diagram of a distributed environment having a client computer system and a server computer system that communicate according to principles of the present invention.

FIG. 2 is a functional diagram of a computer system that may incorporate aspects of the present invention.

FIG. 3 is a block diagram illustrating software components of the present invention.

FIG. 4 is a block diagram of a lock object that may be modified or transferred according to the present invention.

FIG. 5 is a flow diagram illustrating the functional components of modifying an existing lock to change the properties associated with the lock according to aspects of the present invention.

FIG. 6 is a flow diagram illustrating the functional components of transferring a lock according to the present invention.

### DETAILED DESCRIPTION OF THE INVENTION

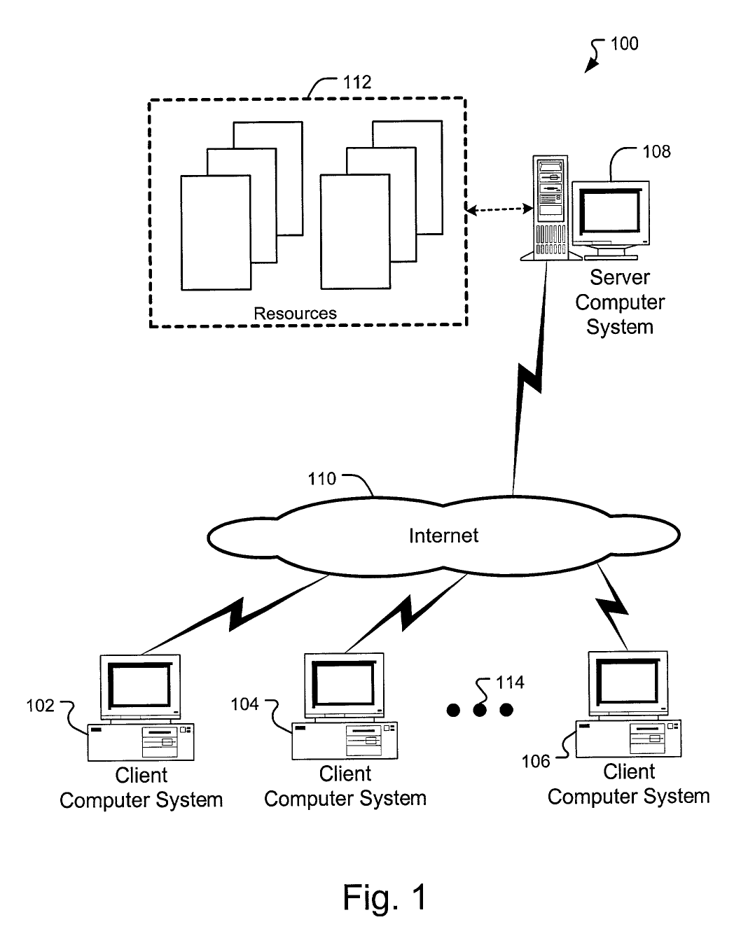

A distributed environment 100 incorporating aspects of the present invention is shown in FIG. 1. The environment 100 has at least one client computer system, such as client computer systems 102, 104 and 106 that interact with at least one server computer system, such as server computer system 108 over a distributed network, such as the Internet 110. The client computer systems 102, 104 and 106 request access to one or more server computer resources 112. Additionally, there may be other client computer systems as indicated by ellipses 114. The resources 112 relate to computer readable files or objects, such as text documents, application program modules, data objects, properties or attributes for data objects, among others. The resources may be HTML, XML, SGML files, or in other embodiments, the resources may be in another format.

In an embodiment of the invention, the protocol used by the systems 102, 104, 106 and 108 to communicate is the WebDAV (World Wide Web Distributed Authoring and Versioning, hereinafter “DAV”) protocol. DAV is an extension of the Hypertext Transfer Protocol version 1.1 (HTTP) and provides the methods and formats for allowing client computer systems, such as computer systems 102, 104 and 106 to access and edit computer resources 112. As stated in the Background Section above, DAV also provides a set of headers and methods, which extend the HTTP to provide capabilities for property and namespace management, among other features as discussed in Proposed Standard RFC 2518.

As one client computer system, such as system 102, accesses one of the resources 112, that resource may be locked such that the other client computer systems, such as systems 104 and 106 are unable to access the resource for any purpose. In other embodiments, one or the other computer systems 104 and 106 may access the locked resource, but only for limited purposes, such as to write to the resource, read the resource or to delete the resource depending on the type of lock used on the resource by the first client computer system. In yet another embodiment, the lock may be considered advisory, such that the other client computer systems 104 and 106 may decide whether to honor the lock or to ignore the lock and access the resource accordingly.

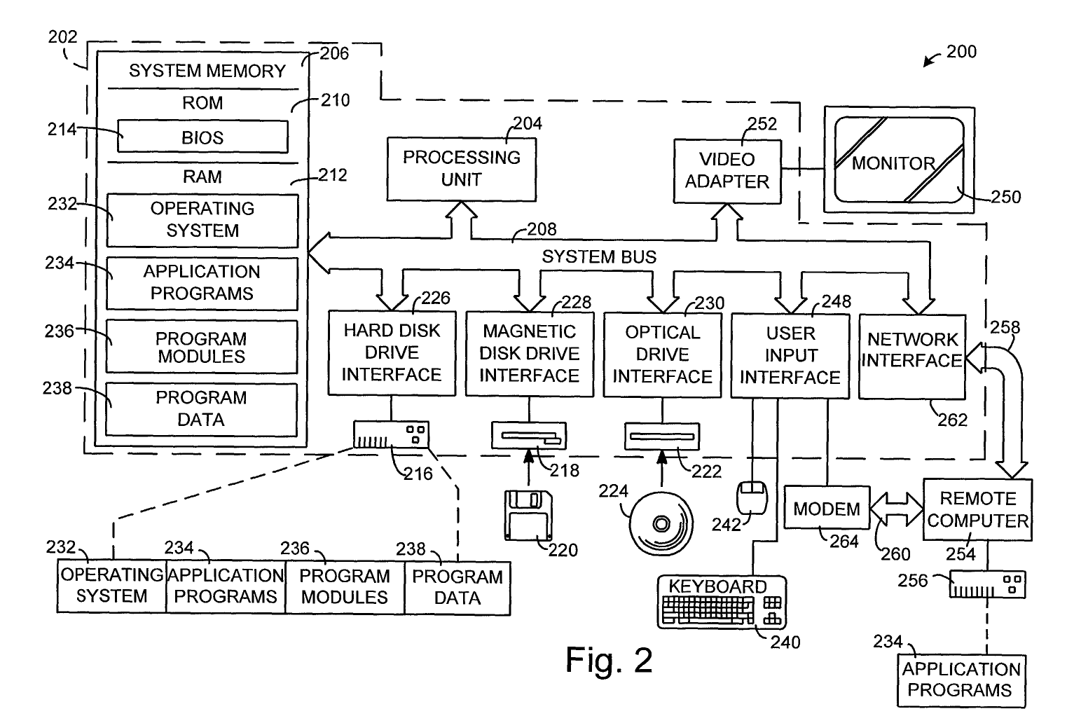

FIG. 2 illustrates an example of a suitable computing system environment 200 in which aspects of the present invention may be implemented as either a client computer system such as systems 102, 104 or 106 or server computer system 108. The computing system environment 200 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary operating environment 200.

Environment 200 incorporates a general purpose computing device in the form of a computer 202. Components of computer 202 may include, but are not limited to, a processing unit 204, a system memory 206, and a system bus 208 that couples various system components including the system memory to the processing unit 204. The system bus 208 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architectures (MCA) bus, Enhanced ISA (EISA) bus, Video Electronics Standards Association (VESA) local bus, and Peripheral Component Interconnect (PCI) bus also known as Mezzanine bus.

Computer 202 typically includes a variety of computer readable media. Computer readable media can be any available media that can be accessed by computer 202 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDE-ROM, digital versatile disks (DVD) or other optical disk storage, magnetic cassettes, magnetic tape, magnetic disk storage or other magnetic storage devices, or any other medium which can be used to store the desired information and which can be accessed by computer 202. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 206 includes computer storage media in the form of volatile and/or nonvolatile memory such as read only memory (ROM) 210 and random access memory (RAM) 212. A basic input/output system 214 (BIOS), containing the basic routines that help to transfer information between elements within computer 202, such as during start-up, is typically stored in ROM 210, while RAM 212 typically contains files and/or program modules that are immediately accessible to and/or presently being operated on by processing unit 204. By way of example, and not limitation, FIG. 2 illustrates operating system 232, application programs 234, other program modules 236, and program data 238. Additionally, the computer 202 comprises a file system, which defines the format for the files of system 202, and further defines version-specific property formats, as discussed below.

The computer 202 may also include other removable/non-removable, volatile/nonvolatile computer storage media. By way of example only, FIG. 2 illustrates a hard disk drive 216 that reads from or writes to non-removable, nonvolatile magnetic media, a magnetic disk drive 218 that reads from or writes to a removable, nonvolatile magnetic disk 220, and an optical disk drive 222 that reads from or writes to a removable, nonvolatile optical disk 224 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 216 is typically connected to the system bus 208 through a non-removable memory interface such as interface 226, and magnetic disk drive 218 and optical disk drive 222 are typically connected to the system bus 208 by a memory interfaces, such as interfaces 228 and 230, respectively.

The drives and their associated computer storage media discussed above and illustrated in FIG. 2, provide storage of computer readable instructions, data structures, program modules and other data for the computer 202. In FIG. 2, for example, hard disk drive 216 is illustrated as storing operating system 232, application programs 234, other program modules 236, and program data 238.

A user may enter commands and information into the computer 202 through input devices such as a keyboard 240 and pointing device 242, commonly referred to as a mouse, trackball or touch pad. Other input devices (not shown) may include a microphone, joystick, game pad, satellite dish, scanner, or the like. These and other input devices are often connected to the processing unit 204 through an input interface 248 that is coupled to the system bus 208. A monitor 250 or other type of display device may also be connected to the system bus 208 via video adapter 252. In addition to the monitor, computers may also include other peripheral output devices such as speakers and printer not shown.

The computer 202 may operate in a networked environment using logical connections to one or more remote computers, such as a remote computer 254. The remote computer 254 may be a personal computer, a server, a router, a network PC, a peer device or other common network node, and typically includes many or all of the elements described above relative to the computer 202.

When used in a LAN networking environment, the computer 202 is connected to the LAN through a network interface or adapter 262. When used in a WAN networking environment, the computer 202 typically includes a modem 264 or other means for establishing communications over the WAN, such as the Internet. The modem 264, which may be internal or external, may be connected to the system bus 208 via the user input interface 248, or other appropriate mechanism. In a networked environment, program modules depicted relative to the computer 202, or portions thereof, may be stored in the remote memory storage device. It will be appreciated that the network connections shown are exemplary and other means of establishing a communications link between the computers may be used.

In addition to the environment 200 shown in FIG. 2, the invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Moreover, the present invention may be described in the general context of a software operating environment, e.g., computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

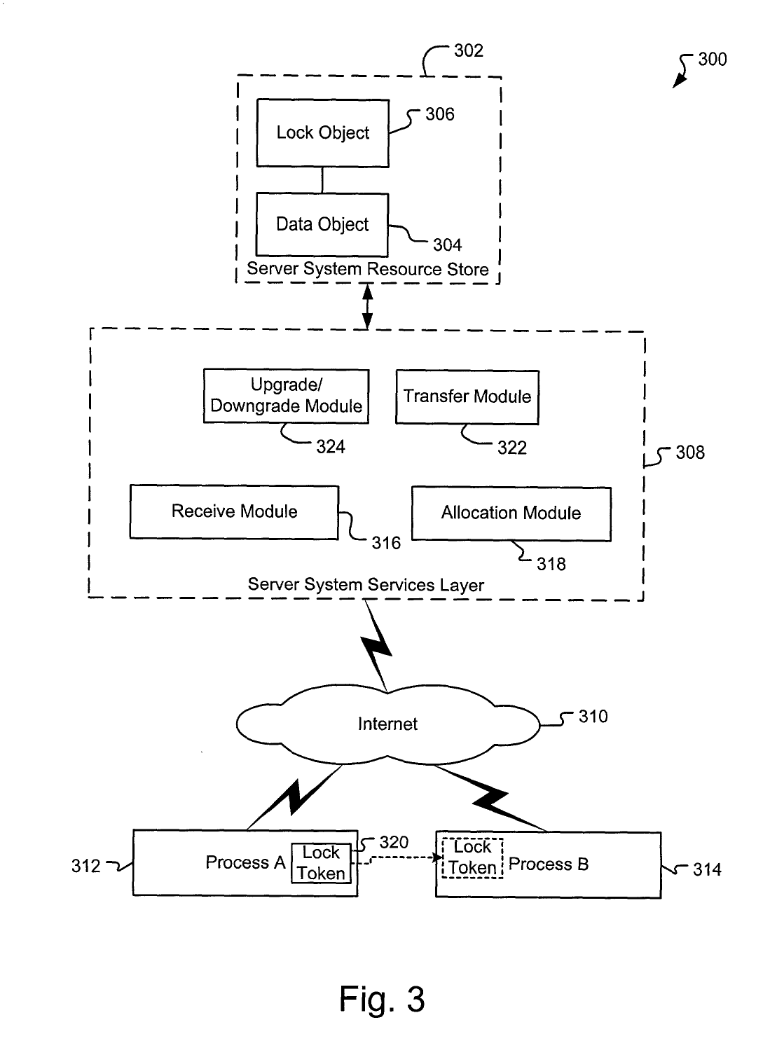

FIG. 3 illustrates an example of a software operating environment 300 in which the invention may be implemented. The software operating environment 300 is only one example of a suitable operating environment and is not intended to suggest any limitation as to the scope of use or functionality of the invention. Software environment 300 incorporates a Server System Resource Store 302 which defines the format and structure of data objects, such as data object 304. Typically, the Server System Resource Store 302 also provides the overall structure in which objects are named, stored and organized. Additionally, the store provides the protocols for accessing any object within the store 302. In an embodiment, Store 302 is an XML store and has data objects defined by the XML standard. However, it is contemplated that other data object configurations or collections may incorporate the aspects of the present invention. Data object 304 is a data object that represents actual file-type data. The object 304 may be accessed and/or modified by a user or another program module. Of course, the Store 302 may comprise many other objects (not shown), which are similar in structure to data object 304.

Typically, each data object 304 has some form of meta information object (not shown) that is associated with each object, the meta information comprises information such as the author of the object, the time the object was last accessed, among others. This meta information may be stored as part of the data object or as part of another object having a pointer or some other identifying element that associates the meta information object with its particular data object.

In addition to the meta information objects, a data object may also be associated with a lock object, such as object 306. Lock object 306 is associated with data object 304. Lock objects comprise information related to whether its associated data object is locked and therefore inaccessible by other client computer systems. Additionally, lock object 306 may provide other functions, such as providing control over the types of locking methods, and/or the servicing of lock token requests. Although shown as separate objects, lock object 306 may be incorporated into the data object itself as part of a header or some other meta-information portion of the data object.

Environment 300 also has a services layer 308, which relates to server functionality in servicing access requests for data objects, such as object 304. The services layer 308 may provide various functions, such as ensuring that an object access request complies with the existing protocol; whether the request relates to either an existing object or, in DAV, to an object that is to be created; whether the module making the request has permission to make and perform the request; among others. The services layer 308 also manages the availability of resources based on lock analysis as discussed in more detail below.

The services layer 308 receives requests over a distributed network environment, such as Internet 310. The requests are made by client computer applications, and in particular applications running processes, such as processes A and B, 312 and 314, respectively. In one embodiment, application program process A 312 is a client application program that operates on a client system apart from a server system, wherein the server system is the physical location of the Store 302. In other embodiments however, the application program process A 312 may actually be part of the server system. Additionally, in one embodiment, the processes A and B, 312 and 314 respectively, are part of the same client application program, yet in other embodiments the processes 312 and 314 are not part of the same application program. In such an environment, the processes 312 and 314 may not even be located on the same client computer system, such as system 102 shown in FIG. 1.

With respect to the lock object 306, in an embodiment of the invention, application program processes 312 and 314 may cause the creation of lock object 306. Alternatively, the services layer 308 may create the lock objects, and associate the object with the data object, such as object 304. Once a lock object, e.g., lock object 306, has been created, another application may determine the existence of such a lock object and access the locked data object only in accordance with parameters set by the lock object, if at all.

In one particular example, the services layer 308 actually performs the creation and management of the lock object 306. The services layer receives a request via a receive module 316 from a process, such as process A 312. Once received, the layer 308 determines whether the client application process, such as process A 312 may access the data object in the requested manner. If the application is able to access the data object in the requested manner, the services layer allocates the lock 306 to the process A 312 via allocation module 318. In allocating the lock, in this example, the allocation module 318 returns a lock token 320 to the client application program process 312 and allows the requested access. If the services layer 308 determines that the application program process 312 may not access the requested data object in the requested manner, such as to read, write, or delete the resource, access is denied.

The services layer 308 may provide other functions to the processes 312 and 314. For instance, the layer 308 may provide the ability to transfer the lock 306 from one owner, e.g., process A 312 to another owner, e.g., process B 314. The layer 308 has a transfer module 322 that may be used for such a purpose. In one embodiment, the transfer module 322 analyzes the request to determine whether a transfer is requested. Once requested, the transfer module determines whether the transfer may occur, i.e., whether other conflicts may occur in attempting the transfer. The transfer module 322 modifies the ownership property within the lock object, such as object 306. Allocation module 318 may then, in one embodiment, provide a new cookie or lock token to the new process, such as process B 314 indicating the transfer of ownership. Additionally, the lock token earlier provided to the process A 312 is removed or simply rendered obsolete since the ownership property as been changed. This process effectively transfers the lock token for object 306 from process A 312 to process B 314.

The services layer 308 also provides the ability to modify other properties of the lock object 306. As described in more detail below, the layer 308 has an upgrade/downgrade module 324 that may be used to change various properties within the lock object 306. For example, a process such as process A 312 may request to modify the scope or type properties of the lock object 306 from an exclusive lock to a shared lock, or from a read lock to a write lock, or from a mandatory lock to an advisory lock, etc. Indeed, the upgrade/downgrade module 324 may be used to modify many different lock properties. Additionally, in an alternative embodiment, the upgrade/downgrade module 324 may also be used to modify ownership properties, thus, performing a transfer of ownership from one process to another as the transfer module 322 described above.

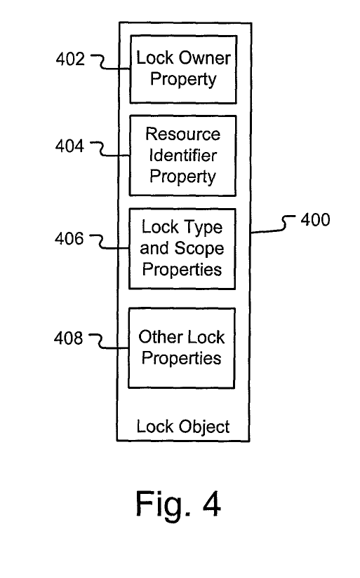

To better understand the transfer module 322 and the upgrade/downgrade module 324, an illustration of a lock object 400 along with some of the lock object properties is shown in FIG. 4. The lock object 400 has information associated with it, known as meta information which essentially defines the properties of the lock. The meta information may include such properties as lock owner 402, resource identifier 404, lock scope and type properties 406 as well as other properties 408. The properties 402, 406 and 408 may be individually modified without unlocking the resource associated with the lock. Additionally, the resource identifier property 404, to the extent that it may relate to more than one resource, may also be modified to include other resources, and or remove some resources without changing the existence of the lock on any remaining resource(s).

In an embodiment of the invention, an “update lock” method is defined and used to modify lock properties. In this embodiment, the update lock method is an extension of the HTTP, as part of DAV. In essence, the update lock method is a new type of DAV method used by the services layer to recognize requests to change lock properties. In order to define the new method, a document type definitions (DTD) is created, such as the example shown in Table 1. Of course the sample DTD shown in Table 1 could also be written as a schema.

TABLE 1
Sample DTD Definition For Lock Modifications

| | |
|---|---|
| 1 | Name: updatelock |
| | Namespace: DAV: |
| | Purpose: Describes how a lock is to be updated. |
| | Description: This XML element describes how a lock is to be |
| | updated. New resources can be added to the lock, lock types can be |
| | upgraded or downgraded, and, in this embodiment, lock ownership |
| | can be changed. |
| | <!ELEMENT updatelock (href, bulklock+)> |

Table 2 illustrates an example using the upgrade lock method defined in Table 1. The example requests a modification to an existing lock from an advisory, shared lock with type “nosharewrite” to an exclusive, mandatory lock with type (“nosharewrite”, “noshareread”). Additionally, for the example shown in Table 2, assume that the lock has been acquired previously on the URI “/container/dir2/dir3/file4” and that the URI “/container/file1” is also associated with this lock, but the request need only specify a lockinfo entry for the changes.

TABLE 2
Example Request and Responses For an Upgrade

| >>Request | UPDATELOCK/container/HTTP/1.1 |
|---|---|
| | Host: webdav.microsoft.com |
| | Timeout: Infinite, Second-4100000000 |
| | Content-Type: text/xml; charset=“utf-8” |
| | Content-Length: xxxx |
| | Authorization: Digest username=“jgoldick”, |
| | realm=“jgoldick@webdav.microsoft.com”, nonce=“...”, |
| | uri=“/container/”, |
| | response=“...”, opaque=“...” |
| | <?xml version=“1.0” encoding=“utf-8” ?> |

```
<D:updatelock xmlns:D=‘DAV:’>
<D:href>
  opaquelocktoken:e71d4fae-4may-22d6-fea5-00a0c91e6be4
</D:href>
<D:bulklock>
  <D:depth>Infinity</D:depth>
  <D:lockinfo>
```

<D:lockscope><D:exclusive/></D:lockscope>
<D:locktype><D:nosharewrite/></D:locktype>
<D:locktype><D:noshareread/></D:locktype>

<D:lockenforcementrule><D:mandatory/></D:lockenforcementrule>

<D:href>/container/dir2/dir3/file4<D:href>

</D:lockinfo>
</D:bulklock>
</D:updatelock>

| | |
|---|---|
| >>Response | HTTP/1.1 200 OK |
| for a | Content-Type: text/xml; charset=“utf-8” |
| Success | Content-Length: xxxx |
| Case | <?xml version=“1.0” encoding=“utf-8” ?> |

<D:prop xmlns:D=“DAV:”>
<D:lockdiscovery>
<D:activelock>

<D:lockscope><D:exclusive/></D:lockscope>
<D:locktype><D:nosharewrite/></D:locktype>
<D:locktype><D:noshareread/></D:locktype>
<D:depth>Infinity</D:depth>
<D:owner>
<D:href>
http://www.microsoft.com/˜jgoldick/contact.html
</D:href>
</D:owner>
<D:timeout>Second-604800</D:timeout>
<D:locktoken>
<D:href>
opaquelocktoken:e71d4fae-4may-22d6-fea5-00a0c91e6be4
</D:href>
</D:locktoken>

<D:lockenforcementrule><D:mandatory/></D:lockenforcementrule>

<D:expectedlifetime>Second-3600</D:expectedlifetime>
<D:href>/container/dir2/dir3/file4</D:href>

</D:activelock>
</D:lockdiscovery>

| | </D:prop> |
|---|---|
| >>Response | HTTP/1.1 207 Multi-Status |
| for a Failure | Content-Type: text/xml; charset=“utf-8” |
| Case | Content-Length: xxxx |
| | <?xml version=“1.0” encoding=“utf-8” ?> |
| | <D:multistatus xmlns:D=“DAV:”> |
| | <D:response> |

```
  <D:href>http://webdav.microsoft.com/container/dir2/dir3/file4/secret
  </D:href>
  <D:status>HTTP/1.1 403 Forbidden</D:status>
```

</D:response>
<D:response>
<D:href>http://webdav.microsoft.com/container/dir2/dir3/file4</D:href>

```
<D:propstat>
<D:prop>
  <D:lockdiscovery>
  <D:activelock>
```

<D:lockscope><D:shared D:locklimit=Infinity></D:lockscope>
<D:locktype><D:nosharewrite/></D:locktype>
<D:depth>Infinity</D:depth>
<D:owner>

<D:href>
http://www.microsoft.com/˜jgoldick/contact.html
</D:href>

```
</D:owner>
<D:timeout>Second-604800</D:timeout>
<D:locktoken>
<D:href>
  opaquelocktoken:e71d4fae-4may-22d6-fea5-00a0c91e6be4
  </D:href>
</D:locktoken>
<D:lockenforcementrule><D:advisory/></D:lockenforcementrule>
```

<D:expectedlifetime>Second-3600</D:expectedlifetime>
<D:href>/container/dir2/dir3/file4</D:href>

</D:activelock>
</D:lockdiscovery>
</D:prop>
<D:status>HTTP/1.1 424 Failed Dependency</D:status>

</D:propstat>

</D:response>
</D:multistatus>

As shown, Table 2 illustrates both a success case and a failure case. With respect to the Success Case, the upgrade request is granted and completed. Furthermore, in the success case, the action not only upgrades the lock but also refreshes the lock, resetting any timeouts. In this case, the nonce, response, and opaque fields have not been calculated in the authorization request header. Moreover, returning lockdiscovery information for resources that were not updated is optional as shown above.

With respect to the failure case, the error is a 403 (Forbidden) response on the resource “http://webdav.microsoft.com/container/dir2/dir3/file4/secret.” Because this resource could not be locked in a more restrictive way than previously, none of the resources had their locks updated. Additionally, the lockdiscovery property for the Request-URI has been included as required. In this example the lockdiscovery property matches the state of the lock before the “updatelock” request was made. In this case, it is permissible for the server to refresh the lock even when the update has failed. Further, the server is not required to return lockdiscovery information for “file1” even though the same lock covers it.

Table 3 illustrates yet another example using the upgrade lock method described above. In this example, the lock ownership is atomically transferred from one process to another. Hence, the upgrade lock method allows ownership of a resource to be passed without opening processes or windows in which another process may acquire a conflicting lock. For the example shown in Table 3, assume that the lock has been acquired previously with lockscope exclusive, locktype (nosharewrite, noshareread), lockenforcementrule mandatory, and Depth: Infinity by principal named “jgoldick”.

TABLE 3
Example Request and Response For a Lock Transfer

| >>Request | UPDATELOCK/container/HTTP/1.1 |
|---|---|
| | Host: webdav.microsoft.com |
| | Content-Type: text/xml; charset=“utf-8” |
| | Content-Length: xxxx |
| | Authorization: Digest username=“jgoldick”, |
| | realm=“jgoldick@webdav.microsoft.com”, nonce=“...”, |
| | uri=“/container/”, |
| | response=“...”, opaque=“...” |
| | <?xml version=“1.0” encoding=“utf-8” ?> |

```
<D:updatelock xmlns:D=‘DAV:’>
<D:href>
  opaquelocktoken:e71d4fae-4may-22d6-fea5-00a0c91e6be4
</D:href>
<D:bulklock>
  <D: depth>Infinity</D:depth>
  <D:lockinfo>
```

<D:lockscope><D:exclusive/></D:lockscope>
<D:locktype><D:nosharewrite/></D:locktype>
<D:locktype><D:noshareread/></D:locktype>
<D:owner>

<D:href>http://www.microsoft.com/˜jsg/contact.html</D:href>

</D:owner>

<D:lockenforcementrule><D:mandatory/></D:lockenforcementrule>

<D:href>/container/dir2/dir3/file4</D:href>

</D:lockinfo>
</D:bulklock>
</D:updatelock>

| | |
|---|---|
| >>Response | HTTP/1.1 200 OK |
| for a | Content-Type: text/xml; charset=“utf-8” |
| Success | Content-Length: xxxx |
| Case | <?xml version=“1.0” encoding=“utf-8” ?> |

<D:prop xmlns:D=“DAV:”>
<D:lockdiscovery>
<D:activelock>

```
<D:lockscope><D:exclusive/></D:lockscope>
<D:locktype><D:nosharewrite/></D:locktype>
<D:locktype><D:nonshareread/></D:locktype>
<D:depth>Infinity</D:depth>
<D:owner>
  <D:href>
  http://www.microsoft.com/˜jsg/contact.html
  </D:href>
</D:owner>
</D:locktoken>
  <D:href>
  opaquelocktoken:e71d4fae-4may-22d6-fea5-00a0c91e6be4
  </D:href>
</D:locktoken>
```

<D:lockenforcementrule><D:mandatory/></D:lockenforcementrule>

<D:href>/container/dir2/dir3/file4</D:href>

</D:activelock>
</D:lockdiscovery>
</D:prop>

The example shown in Table 3 requests transfer of lock ownership from “jgoldick” to “jsg”. It also refreshes the lock, resetting any time outs. In this example, the nonce, response, and opaque fields have not been calculated in the Authorization request header. If the new owner were not a valid principal, a “403 code” would have been returned. Returning lockdiscovery information for resources that were not updated is optional, “/container/file1” in this example.

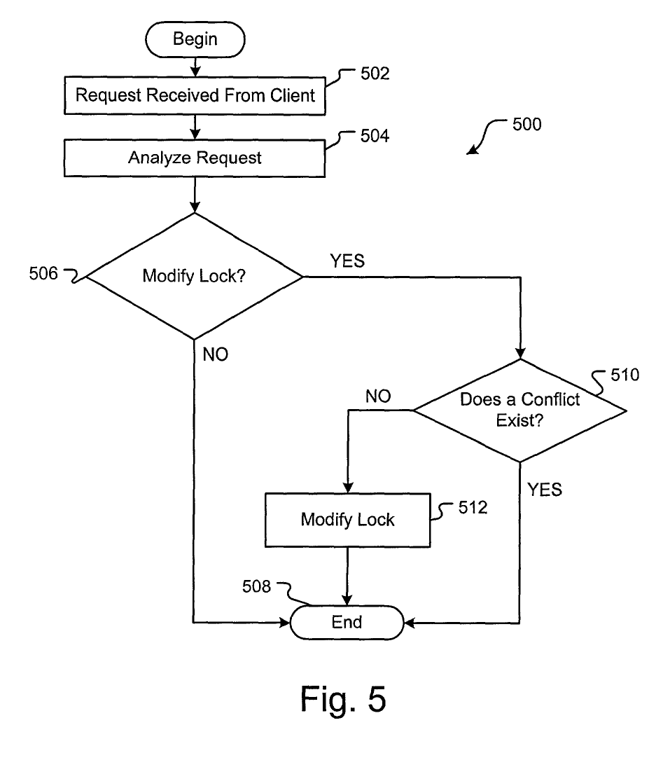

FIG. 5 is a flow chart of the operational characteristics related to modifying properties for a lock object according to aspects of the present invention. Prior to the beginning of flow 500, an object, such as object 306 shown in FIG. 3, may already exist within a Server System Resource Store, such as store 302. In such an embodiment, once the object has been created, then any later attempt to access that object may initiate flow 500.

Process 500 generally begins with receive operation 502, wherein the receive operation 502 relates to the receipt, by the server system of any read, execution, or update access request related to an object. In this case, the request relates to an existing lock object, such as object 306 and the request is made by the lock owner. The access request incorporates information indicating that the requesting principal is the owner and may further indicate other identifying information.

Once received, analyze request operation 504 analyzes the request. Analysis operation 504 determines whether the request was made by the owner of the existing lock or whether a new lock is to be created, among other things. If the request relates to an existing lock and the requesting principal is the lock owner, then determination operation 506 determines whether the request is to modify the lock. In an embodiment, determination operation 506 analyzes the various components of the existing lock request and determines that the lock should be modified. For instance, determination operation 506 may search for a specific command in the request identifying that the modification should occur. The existence of an “upgrade lock” or “update lock” line within the request may indicate such a desire to modify the lock. In a particular embodiment, the command is an “updatelock” request as defined in Table 1 above and illustrated in the examples shown in Table 2.

If determination operation 506 determines that the lock should not be modified, i.e., wherein the request does not include a request to modify the lock, flow branches “NO” to end operation 508. End operation effectively ends the determination loop as to whether the lock should be modified.

If determination operation 506 determines that the lock should be modified, then flow branches “YES” to conflict check operation 510. Conflict check operation 510 analyzes the actual update or upgrade request to determine what type of modification is requested. In analyzing the type of modification requested, conflict check 510 is able to then determine whether other locks exist that may in fact conflict with the requested modification or whether the lock itself cannot be modified for some reason.

For example, if the lock modification request indicates a desire to modify the lock from a shared lock type to an exclusive lock type, then conflict check 510 determines whether other shared locks exist with respect to that resource. If other shared locks exist with respect to the resource, then a conflict exists such that the modification cannot proceed. Of course, many other potential conflicts may exist depending on the type of modification requested.

If conflict operation 510 determines that a conflict exists, then flow branches “YES” to end operation 508 which effectively ends flow 500. In an embodiment, a response may also be sent back to the requesting principal indicating that a conflict exists and, therefore, the modification request has been denied.

If conflict check operation 510 determines that no conflict exists, then flow branches “NO” to modify lock operation 512. Modify lock operation 512 modifies the lock properties according to the request.

Following modification operation 512, flow branches to end operation 508, which ends the modification flow 500.

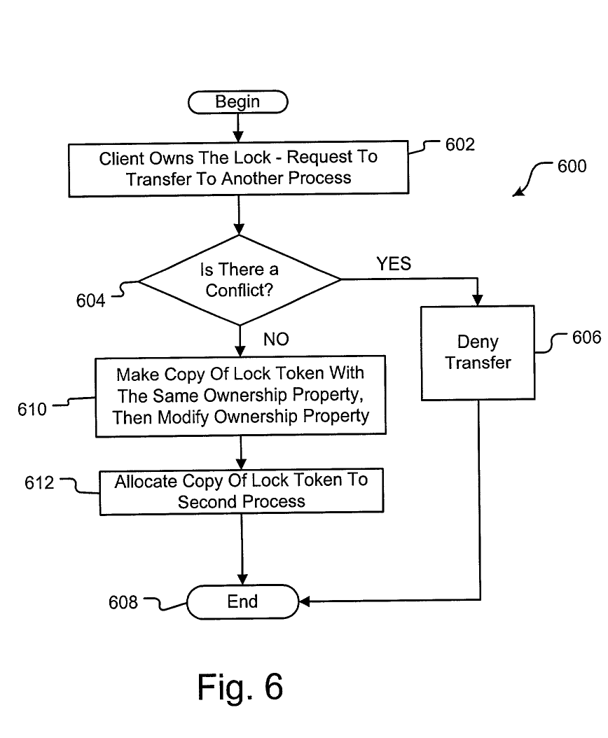

FIG. 6 is a flowchart of the operational characteristics related to an embodiment of the invention wherein the modification of the lock object relates to transferring ownership of a lock object from one process to another. In an embodiment, flow 600 is similar to flow 500 shown and described above with respect to FIG. 5 wherein the modification of the ownership property may be completed via flow 500 shown in FIG. 5. However, as the transfer of ownership may require atomicity, flow 600 may be used. Prior to the beginning of flow 600, an object such as object 306 shown in FIG. 3 may already exist within a server resource store, such as store 302. In such an embodiment once the object has been created then any later attempts to access that object may initiate flow 600 shown and described with respect to FIG. 6.

Process 600 begins with the receive operation 602 wherein the receive operation relates to the receipt, by the server system of a transfer ownership request relating to an existing lock object, such as object 306, and the request is made by the lock owner. The request incorporates information indicating that the requesting principal is the owner and may further indicate other identifying information as needed. Accordingly, receive operation 602 may perform any checks necessary to determine that the request is made by the lock owner. Additionally, operation 602 may further analyze the request to determine that the request is to transfer lock ownership. If operation 602 determines that the lock owner made the request and the request is to transfer the lock to another process flow, branches to determination operation 604.

Determination operation 604 determines whether there is a conflict. For instance, determination operation 604 may determine whether there is a conflicting lock that would prevent such a transfer of ownership. For instance, there may be shared locks in association with the resource that may prevent transfer to a second process wherein the second process requires exclusivity. Alternatively, there may be other reasons or conflicts that would prevent such a transfer of ownership.

If a conflict exists, lock or otherwise, flow branches “YES” to deny transfer operation 606. Deny transfer denies the transfer of ownership and flow branches to end operation 608. Additionally, following the denial of the transfer of ownership, a message may be sent to the requesting principal indicating that the transfer was denied and may further indicate the reason.

If no conflict exists, as determined by determination operation 604, then flow branches “NO” to copy operation 610. Copy operation 610 creates a copy of the lock token as owned by the requesting principal. Making a copy of the lock token essentially creates two tokens for the same associated object. The lock token is then modified to contain the new process ownership information.

Following copy operation 610, allocate operation 612 provides the copy of the lock token with the new ownership information to the second process. Allocate operation 612 effectively transfers the lock ownership from the first process to the second process. Following allocate operation 612, flow branches to end operation 608.

Furthermore, following allocate operation 612, delete or kill operation (not shown) may be employed to delete or omit the first token as owned by the initial requesting process. However, since the lock token has been transferred to the second process, with the new owner, the initial lock owner could not qualify as the lock owner such that deleting the initial lock token is unnecessary.

The transfer of lock ownership in this manner does not remove a lock from an existing object such that any other processes or application programs desiring access to the object find that the object is unlocked even during such transfer period. Thus, no intervening or intermediate users or client avocation programs can access the data objects during a transfer of control shown in FIG. 6.

As discussed above, the invention described herein may be implemented as a computer process, a computing system or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

Additionally, although the invention has been described in language specific to structural features and/or methodological steps, it is to be understood that the invention defined in the appended claims is not necessarily limited to the specific features or steps described. Therefore, the specific features and steps are disclosed as preferred forms of implementing the claimed invention.

What is claimed is:

1. A method of modifying a lock associated with a resource in a distributed environment, the method comprising:
receiving a request to modify the lock, wherein the request originates from a requesting client computer system;
analyzing the request to determine whether the request is made by the lock owner; and
if the request is made by the lock owner, modifying at least one property associated with the lock.

2. The method as defined in claim 1 wherein the method further comprises:
following the determination of whether the request is made by the lock owner, determining whether the resource is locked by another client computer system that may conflict with the requested modification; and
if the resource is locked by a conflicting lock, denying the received request.

3. A method as defined in claim 1 wherein the request relates to modifying the lock type.

4. A method as defined in claim 1 wherein the request relates to the modification of the lock scope.

5. A method as defined in claim 1 wherein the request relates to the modification of the lock ownership.

6. A computer program product readable by a computer and encoding instructions for executing the method recited in claim 1.

7. A computer program product readable by a computer and encoding instructions for executing the method recited in claim 5.

8. A computer-readable medium having stored thereon a locked resource, wherein the locked resource comprises:
a resource object data section for storing actual object data;
a lock object, wherein the lock object comprises a plurality of properties, wherein a first property identifies a lock owner, and wherein the properties may be modified by the lock owner.

9. A computer-readable medium as defined in claim 8 wherein a second property relates the resource object and wherein the second property may be modified by the lock owner to associate the lock object with a second resource object.

10. A computer-readable medium as defined in claim 8 wherein the lock owner may modify the first property relating to lock ownership to transfer the lock object to a second owner.

11. A system for modifying a lock object in a distributed environment, the distributed environment having a plurality of resources and wherein at least one resource is associated with the lock object, the system comprising:
a receive module for receiving a resource request from a requesting process, wherein the request includes modification information;
a determination module for determining whether the requesting process owns the lock object associated with the resource; and
an update module for modifying the lock object upon a determination that the requesting process owns the lock object.

12. A system as defined in claim 11 wherein the determination module also determines whether there is a conflicting lock associated with the requested resource and wherein the update module does not modify the lock object upon a determination that a conflicting lock exists.

13. A system as defined in claim 12 wherein the lock object has a lock type property, and wherein the update module modifies the lock type property.

14. A system as defined in claim 12 wherein the lock object has a lock scope property, and wherein the update module modifies the lock scope property.

15. A system as defined in claim 12 wherein the lock object has a lock ownership property, and wherein the update module modifies the lock ownership property to thereby transfer the lock object from one process to another.

16. A system as defined in claim 11 further comprising a transfer module for transferring ownership of the lock object from the requesting process to another process.

17. A system as defined in claim 11 wherein the requesting process communicates with the receive module using Web Distributed Authoring and Versioning protocol.
